(19) United States
(12) Patent Application Publication
(10) Pub. No.: US 2020/0394245 A1
(43) Pub. Date: Dec. 17, 2020

(54) Image to Logo Hyperlink Converter

(71) Applicant: Michael P. Nash, Los Angeles, CA (US)

(72) Inventor: Michael P. Nash, Los Angeles, CA (US)

(21) Appl. No.: 16/439,513

(22) Filed: Jun. 12, 2019

(51) Int. Cl. G06F 16/955; G06T 1/00; G06T 11/60

(52) U.S. Cl. CPC G06F 16/9558; G06T 11/60; G06T 1/0007

(57) ABSTRACT

Systems and methods for developing, customizing, and deploying hyperlinked image/logos, that will fit within textual communication; along with other types of communication and data needs. If the image is to large to fit within a single or multiple lines of text, this system and method will compress any sized image, logo, picture into an emoji-like sized hyperlinked image for communication or data. Allowing personal and business users to create customize hyperlinked logos, images, pictures, ideograms for all needs.

### BACKGROUND OF IMAGE TO LOGO HYPERLINK CONVERTER

### 1. Field of the Invention

This exemplary embodiment of the description herein relates to digital communication device applications, and in particular, to digital textual communication device applications converting images into hyperlinked image/logo that fit within linear text.

### 2. Background

The only images or logos used in digital text communication that fit neatly between alphabetic, numbers and or special characters spacing on a single line of text or multiple lines are emoji like character clip art. This method allows users, individuals, groups, companies to create their own emoji-like size logo, ideograms and images; and hyperlink the logo image. Examples of these hyperlinked logos are, but not limited to, sports teams logos, products brands, pop culture icons, music labels, company logos, entertainment brands, university brands, organizational brands, mascot images, ideograms, military logos, vintage brands, abstract mark, iconic logos, mascot logo, combination mark, emblem logo, lettermark, pictorial mark and wordmark. Currently, this method and system is built into a a fully functional, working mobile application. (Pictures of this mobile app included.)

### 3. Related Art

Wireless communication devices have become common in modern society. These wireless communication devices have evolved from simple analog radios to modern smartphones and tablets. As these modern devices continue to evolve, manufactures and software developers are continuously improving the input devices (i.e., microphones, cameras, keyboards, wireless connectivity, such as Bluetooth® and Wi-Fi® technologies) and software applications (generally referred to a “apps”). At present, there are thousands of “apps” available to smartphone, computers, watches and tablet users. These wireless communication devices allow users to use both cellular communication, wifi networks, cloud, digital communications and the Internet for such activities as social media, voice calls, bill paying, shopping, internet surfing, videos, texting, tweets, communication, Instant Messaging, SMS, emailing, education, entertainment etc. There exist larger images online, most on websites, mobile pages that are capable of hyperlink activation, an example of this would be an advertised banner located on a website or mobile page where upon clicking the banner, the user will be redirected to the site/link the the advertiser wish you to see; but no methods are currently available for a user to hyperlink an image that fits within a single line of text; if the user is unable to fit the original image do to size, this method will not only hyperlink, but will compress the larger image, and covert the image into a emoji-like hyperlinked logo.

### BRIEF DESCRIPTION OF THE DRAWINGS

An exemplary embodiment of the description herein can be better understood by referring to the following figures. The components in the figures are not necessarily to scale, emphasis instead being placed upon illustrating the principles of the exemplary embodiment of the description. In the figures, like reference numerals designate corresponding parts throughout the different views.

FIG. 1 is a flowchart of an example of an implementation of a process performed by a logo hyperlink converter, in accordance with the present exemplary embodiment of the description herein.

FIG. 2 is a photo of the working mobile application text page. Within this photo one can sec the compressed hyperlink images located with text.

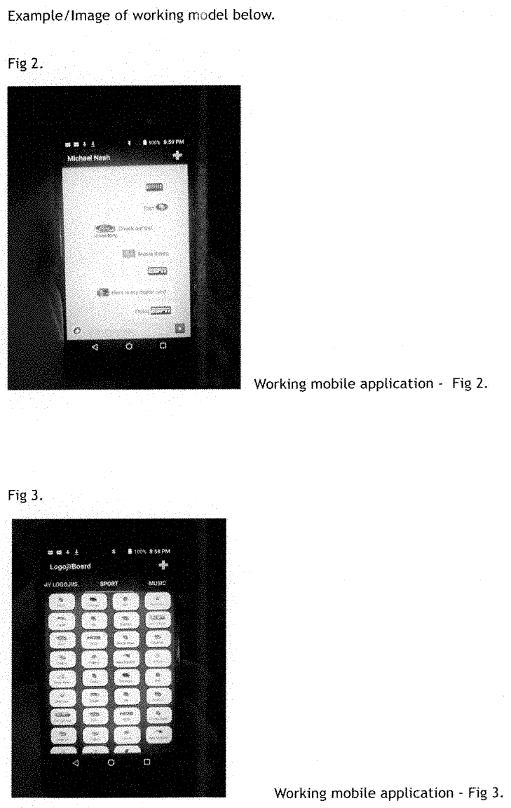

FIG. 3 shows the working mobile application logoboard or library where stored and newly created Logojii arc stored. By clicking on the “+”, the user can create a new hyperlinked logo.

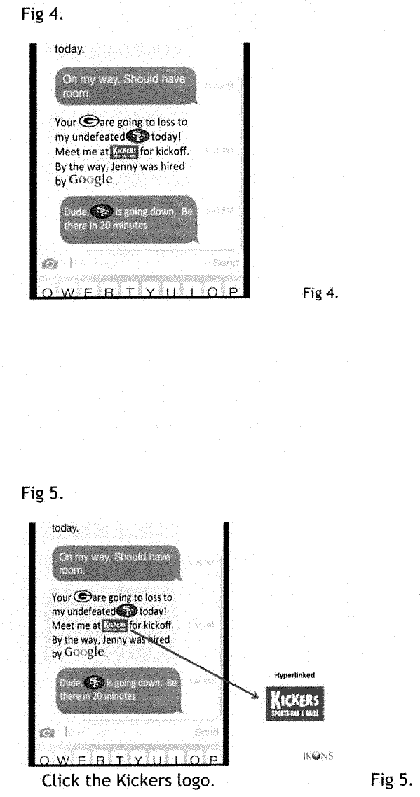

FIG. 4, FIG. 5, and FIG. 6 show a step by step of a user clicking on an hyperlinked image/logo within the text, after clicking, the user is taken to a new location/link, in this case “Kickers” a sports bar website.

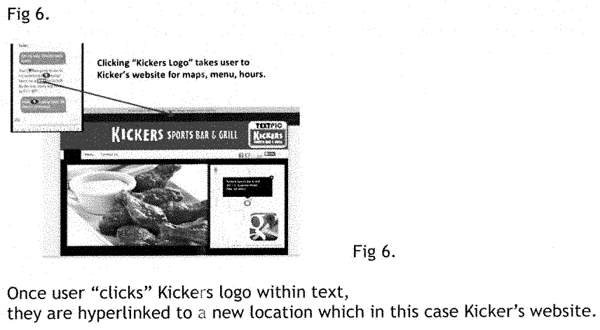

### AN EXEMPLARY EMBODIMENT OF THE DESCRIPTION HEREIN

Disclosed is an image-to-logo hyperlink converter that allows a user to transfer an image to a logo/compressed image that may be utilized in varying types of digital communication platforms and/or streams. The image may be either captured by copying digital images online, by a capturing a digital photo from a camera (or other image capture devices) and/or acquired from another sources like photo galleries.

Also disclosed is a method for finding, saving and then compressing any image with the image-to-logo hyperlink converter. The method may also include inserting the newly compressed image into a digital single text line for communication enhancement. The new compressed images may be saved in a “logo library keyboard” for easy access. In addition, word-coded image, encrypted-coded images, or voice messages converted to text can also work.

Once the user acquires the image, the image is transferred into a logo/compressed image by reducing and/or compressing the original size of the image to a size that is suitable for use in varying types of digital communication platforms and/or streams such as, for example, text, tweets, Instant Messaging, SMS, voice recognition data, emails, clouds, hashtags, social networks, etc. The newly compressed image, that will fit within a single line of text, will be hyperlinked. The new image/logo with hyperlink capabilities, can then be inserted on the same line of the text, into the same line of text, within the text words, to the right or left of the text, within the text line not disrupting the flow of communication. It is also available, if needed, to be inserted into non-linear text. An exemplary embodiment of the description herein then allows the logo to be hyperlinked to additional material as directed by the link URL or data. The hyperlinked logo can also be word-coded and/or meda-data tagged.

An exemplary embodiment of the description herein allows for enhanced image texting using the created logo, or using pre-created logo through our technology by another user. Example, Ford Motors may create a logo that is an emoji-size icon of the Ford brand label, that can be inserted into text communication. The recipient or multiple recipients of this communication will have the ability to click on the Ford logo within their text, email, textual communication and will be instantly sent to where ever Ford Motor company has hyperlinked the icon to. This allows the user to create more colorful, informative, user specific branding, tailor fitted for personal or business lifestyles such as logos for small businesses owners, corporate branding, logos for the high schools, pictures of family and friends, teams they play on, churches they attend, organizations they belong to, non-profits they support, cafes they eat at, coupons they collect. This is only a partial list.

An exemplary embodiment of the description herein makes possible the ability to insert, download, and/or copy-paste any image from the Internet, mobile application, desktops, emails, tweets, texts, drives, clouds, hashtags, IM, SMS, social networks, etc. and convert the pictures and/or image file into a mini version of the original image that can be inserted into a single line of text and/or non-linear text communication usage that will have hyperlink capability for single navigation, bi-directional and many-to-many links. When utilized, the code word will allow the application to substitute the logo for the word code when typed into a text type of application or when spoken in a. voice activated type of application.

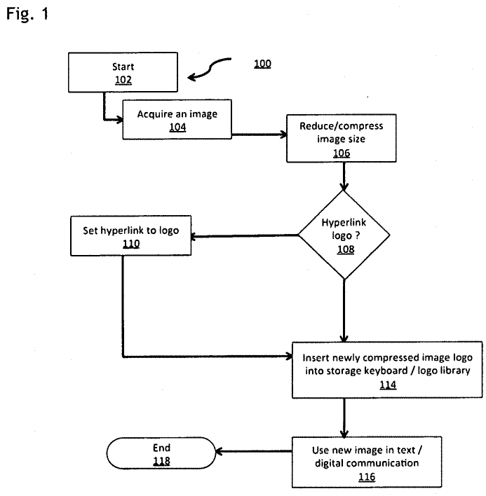

Turning to FIG. 1, a flowchart 100 is shown of an example of an implementation of a process performed by a picture-to-logo converter in accordance with the present exemplary embodiment of the description herein. The process starts at step 102 and, in step 104, the user acquires an image for use in the picture-to-logo hyperlink converter image compressor. The acquired image is then reduced in size, in step 106, to a smaller size image that is suitable for use in varying types of digital communication platforms and/or streams. The image is encrypted for universal usage and data storage. The user may then select whether to hyperlink information to the logo in decision step 108, the process continues to step 110 where the user can hyperlink the image. If the user does not desire to hyperlink the information to the logo, the process continues to step 112. The new smaller image is then placed, in step 114, into a logo keyboard, logo library storage file on a storage device that may be on a mobile telephone, website or on a server located on the Internet or cellular network remote to the mobile telephone and the process directly goes to step 116 allowing the user to use the compressed new image in text and other forms of communication. The new smaller size image, the compressed image may be selected by the user directly or pre-selected by the process based on the requirements of a specific type of digital communication platforms and/or stream that is selected by the user.

Once the logo is hyperlinked to additional information, the logo may be sent to a recipient via a text message, tweet, or other form of textual communication. The logo then allows the recipient to be directed to additional information or Internet locations based on the hyperlink. If the logo has a code word association, once the user begins to type in the code word listed for the image, the image will appear in text.

Once the logo is hyperlinked, it may be hyperlinked to valuable digital information, coupons, offers, inventories, maps, company sales, entertainment, menus, bill paying, corporate websites or saving opportunities, to name a few. In this example, the hyperlinked logo would become a “Logopon” because the logo will be associated with economic opportunities similar to a physical coupon given to potential customers.

Another example of an implementation includes linking the logo with digital maps. In this example, the provider may provide a user with a logo (such as, for example, a car dealership, coffee shop, stadium, hospital, house) that hyperlinks the logo to the physical location, website etc... providing the user with a logo filled with helpful data. As an example, the process may include the business creates an image logo for their coffee shop using our technology. A user who visits that coffee shop frequently has the logo stored in their logo library. The user is meeting a friend who has never been to the coffee shop. The user text their friend the logo. Once received by the recipient, the recipient taps on the image, activating the hyperlink associated with the logo will see a map to the coffee shop, menu of coffee shop, discounts, coupons, reviews of coffee shop.

Another example of an implementation including linking calendar information with a logo that may be sent by a user to a recipient. In this example, by clicking on a digital calendar, the sender is able to send his schedule to a recipient by saving his/her calendar into a calendar icon that may be sent to the recipient.

Another example of an implementation allows for the personalizing and/or branding of phones by starting every text with the same logo or schedule the image for different intervals. As an example, every text may start out with a first logo or it can be schedule to start every text in the morning (for example) with the first logo or every text to a new person, etc.

Further description of the process and system are shown in Attachment A.

Although the previous description only illustrates particular examples of various implementations, an exemplary embodiment of the description herein is not limited to the foregoing illustrative examples. A person skilled in the art is aware that an exemplary embodiment of the description herein as defined by the appended claims can be applied in various further implementations and modifications. In particular, a combination of the various features of the described implementations is possible, as far as these features are not in contradiction with each other. Accordingly, the foregoing description of implementations has been presented for purposes of illustration and description. It is not exhaustive and does not limit the claimed exemplary embodiment of the description herein to the precise form disclosed. Modifications and variations are possible in light of the above description or may be acquired from practicing the exemplary embodiment of the description herein. The claims and their equivalents define the scope of the exemplary embodiment of the description herein.

What is claimed is:

1. A process for converting a image to a logo, compressing the image if needed, and applying the new image into text, the process comprising:
acquiring an image;
reducing the size of the image to a smaller image;
hyperlinking the image;
applying the new image within a single line or multiple lines of text;
storing the smaller image in a logo database and or keyboard;
